(19) United States
(12) Patent Application Publication
(10) Pub. No.: US 2002/0065756 A1
(43) Pub. Date: May 30, 2002

(54) Method of providing information

(75) Inventor: Tatsuya Kunikiyo, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/834,972

(22) Filed: Apr. 16, 2001

(30) Foreign Application Priority Data
Oct. 10, 2000 (JP) 2000-308809

(51) Int. Cl. G06F 17/60

(52) U.S. Cl. 705/36

(57) ABSTRACT

It is an object of the present invention to facilitate financing of an IP vendor and pass a reward worthy of the IP on to the vendor, to thereby encourage the IP vendor to make IP of high quality open to the public and reduce burden of design and proving of IP on a user using IP. IP provided from a vendor is made open to the public in a market, for which stocks are issued. Consideration for the stocks bought by an investor is passed on to the vendor through the market. Consideration determined in response to frequency of use of the IP open to the public is paid from a user using the IP to the market, to thereby indirectly pass the consideration on to the vendor. Allotment is provided from the vendor to the investor.

### BACKGROUND OF THE INVENTION

1. Field of the Invention

The present invention is directed to a technique for providing information that can be distributed electromagnetically such as so-called IP (intellectual property) especially on a semiconductor device.

2. Description of the Background Art

A growth rate of a capacity for manufacturing semiconductor devices has been larger than that of a capacity for designing semiconductor devices, and the difference between these two has been increasing yearly. For example, the capacity for manufacturing semiconductor devices is growing at an annual rate of about 58 percent in terms of the number of logic transistors. In contrast hereto, the capacity of a designer for designing, estimated by the amount of designing, correction of errors and test of semiconductor devices by one designer per month, is growing at an annual rate of about 25 percent or less in terms of the number of logic transistors.

This widened difference between these two capacities is resulted from the fact that there are manifold functional blocks constituting a system LSI and that it takes time for its design and proving. Consequently, it is necessary to increase the number of designers for compensating such widened difference between these capacities to thereby reduce the time for introducing system LSIs into the market.

As compared with a great variety of system LSIs, however, it is difficult to secure enough number of designers under existing circumstances. Therefore, it has been difficult for a manufacturer to perform all the in-house design and proving of system LSIs.

In response thereto, it has been attempted to use so-called IP in a semiconductor device from the outside. Here, IP is a generic name including hardware such as circuit layout and software described in circuit description language, and further including core as design property of a system LSI (mega cell), circuit library, software for a microprocessor for a built-in device and so on. Software describing operating conditions of a semiconductor manufacturing device may be included as well.

IP is made open to the public through communication networks such as the Internet and can be used either at cost or at no charge. Therefore, it is possible for a manufacturer to obtain IP from the outside that can be used to design system LSIs in-house, to improve efficiency of design.

Table 1 shows problems of IP in the background art.

TABLE 1

| Chip Type | System LSIs Manufactured in Flexible Manufacturing System | | |
|---|---|---|---|
| Object | Reduction in Time for Introduction into The Market Using IP | | |
| IP Use | | | |
| Environment | IP Distribution Base | Design Technology | Proving Technology |
| Problems under | Heavy burden of research | Prolonged time for | Evaluation of IP before buying requires time and cost. |
| Existing | and proving | developing derivative chips | Proving of the entire large scale integrated circuit is |
| Circumstances | It is not clear whether | due to absence of design | difficult due to the fact that each IP requires respective |
| | royalty or contract fee to | platform | languages for its description. |
| | be paid to an IP vendor is | No compatibility among IPs | |
| | reasonable against objective | provided by a plurality of | |
| | market prices. | vendors | |
| | | IP operating for one purpose | |
| | | does not function well when | |
| | | operating for another purpose. | |
| | | It takes time to design clock | |
| | | distribution of a large scale | |
| | | integrated circuit manufactured | |
| | | by putting a plurality of IPs | |
| | | together. | |
| | | No optical correction in a | |
| | | region where different IPs are | |
| | | neighboring is guaranteed. | |

Chips to which IP is introduced are system LSIs manufactured in a flexible manufacturing system. There are three environments in which IP is used, namely IP distribution base, design technology and proving technology. Heavy burden of research and proving using networks such as the Internet is cited as one of the problems under existing circumstances related to the IP distribution base. As the problems related to the design technology, the followings are cited:

1. As there is no design platform, it takes time to develop derivative chips;

2. There is no compatibility among IPs provided by a plurality of vendors;

3. The IP operating for one purpose does not function well when operating for another purpose;

4. It takes time to design clock distribution of a large scale integrated circuit manufactured by putting a plurality of IPs together; and

5. Optical correction in a region where different IPs are neighboring is not necessarily guaranteed.

Further, evaluation of IP before buying requires time and cost and proving of the entire large scale integrated circuit is difficult due to the fact that each IP requires respective languages for its description. These points are cited as the problems related to the proving technology.

There are a plurality of sites on the Internet making IP open to the public. However, standards for IP open to the public are not reviewed sufficiently, investment in IP is small and a vendor providing IP cannot necessarily get a reward worthy of IP open to the public. Such problems have resulted in that only a small number of useful IPs has been made open to the public.

### SUMMARY OF THE INVENTION

A first aspect of the present invention is directed to a method of providing information, comprising the steps of: (a) providing security of information to an investor distributed electromagnetically to a user and paying at least part of consideration for the security to a vendor providing the information; (b) paying at least part of consideration for use of the information by the user to the vendor; and (c) paying allotment from the vendor to the investor.

A second aspect of the present invention is directed to a method of providing information in which information is distributed electromagnetically from a vendor to a user through a market, wherein the market performs the steps of: (a) making security of the information open to the public to establish buying and selling by an investor; (b) distributing the information electromagnetically to the user to collect consideration for the use from the user; and (c) transmitting frequency of the use to the vendor to provide at least part of the consideration for the use to the vendor.

A third aspect of the present invention is directed to a method of providing information in which a vendor performs the steps of: (a) distributing information electromagnetically to a user; (b) receiving at least part of consideration for use of the information by the user; and (c) paying allotment to an investor buying security of the information on the basis of frequency of use of the information.

According to a fourth aspect of the present invention, in the method of providing information of any one of the first to third aspects, the step (a) includes the step of (a1) making the stocks only of the information satisfying a predetermined standard open to the public.

According to a fifth aspect of the present invention, in the method of providing information of the fourth aspect, identification is assigned to the information and the identification is specific to the user.

According to a sixth aspect of the present invention, in the method of providing information of any one of the first to third aspects, the step (b) is performed in electronic commerce.

According to a seventh aspect of the present invention, in the method of providing information of any one of the first to third aspects, the consideration for the use is determined on the basis of condition of use of the information in the step (b).

According to an eighth aspect of the present invention, in the method of providing information in any one of the first to the third aspects, the allotment to the investor buying the security corresponding thereto is determined on the basis of frequency of use of the information in the step (c).

In the method of providing information according to the first aspect of the present invention, it is possible for the vendor to obtain the consideration for creating information and providing the same by the step (a) regardless of whether the information is used or not. The allotment based on use of the information is received by the investor by the step (c). The step (c) further enhances value of the stocks, to enable the investor to obtain capital gains potentially. The information distributed electromagnetically is obtained and used by the user easily.

In the method of providing information according to the second aspect of the present invention, since frequency of use of the information is transmitted to the vendor, it is possible for the vendor to pay the allotment determined on the basis of the frequency of use to the investor.

In the method of providing information according to the third aspect of the present invention, the allotment based on use of the information is received by the investor by the step (c). The step (c) further enhances value of the stocks, to enable the investor to obtain capital gains potentially. For this reason, investment from the investor to the vendor is encouraged. The information distributed electromagnetically is obtained and used by the user easily.

In the method of providing information according to the fourth aspect of the present invention, publication of information of high quality is encouraged. Further, burden of improving estate to the user is reduced.

In the method of providing information according to the fifth aspect of the present invention, it is easy to associate the user with the information distributed thereto. Therefore, even when duplication of the information is easy and use of the same may be possible by the person other than the user to which the information is distributed, such use can be detected easily.

In the method of providing information according to the sixth aspect of the present invention, obtention of the information and payment of the consideration for use of the same both can be realized rapidly and easily through delivery and receipt of electromagnetic signals. Therefore, active use of the information can be excited.

In the method of providing information according to the seventh aspect of the present invention, the consideration for use of the information is determined in response to a factor such as level of the information to be used. Therefore, active use of the information can be excited.

In the method of providing information according to the eighth aspect of the present invention, value of the stocks of the information having high frequency of use is increased. Therefore, investment from the investor can be excited.

It is an object of the present invention to facilitate financing of an IP vendor and pass a reward worthy of the IP on to the vendor, to thereby encourage the IP vendor to make IP of high quality open to the public and reduce burden of design and proving of IP on a user using IP.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual view showing a method of providing information according to a preferred embodiment of the present invention.

### DESCRIPTION OF THE PREFERRED EMBODIMENTS

The term “electromagnetically distributable” in the present specification and claims includes not only distribution through communication regardless of whether in a wire system or in a wireless system but also includes distribution by delivery and receipt of medium electromagnetically recorded. The term “electromagnetically recorded” includes not only recording in an electrical and magnetical manner but also includes recording in an optical manner. For example, while image and sound themselves may be regarded as not electromagnetic in most cases, so-called digital contents obtained by converting them into signals correspond to information electromagnetically distributable as described in the present specification.

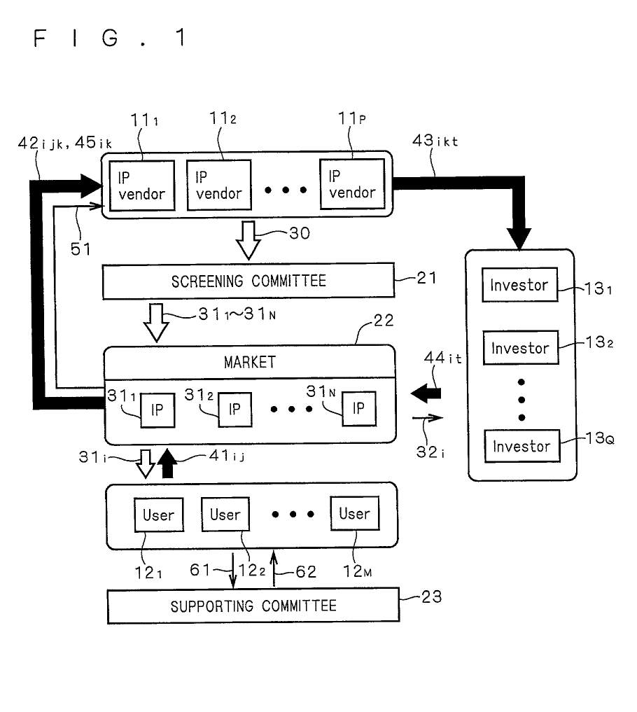

FIG. 1 is a conceptual view showing a method of providing information according to a preferred embodiment of the present invention. In FIG. 1, white arrows designate flow of information electromagnetically distributable such as so-called IP in a semiconductor device and boldface black arrows designate flow of delivery and receipt of money such as employed in electronic commerce.

IP vendors 11₁, 11₂, . . . 11ₚ (hereinafter may be called by a generic name “vendor 11”) distribute IPs 31₁, 31₂, . . . 31_{N} (hereinafter may be called by a generic name “IP 31”) electromagnetically to IP users 12₁, 12₂, . . . 12_{M} (hereinafter may be called by a generic name “user 12”) through an IP market 22 making IPs open to the public. A user 12ⱼ (1≦t≦M) using IP 31₁ (123 i≦N) pays consideration 41ᵢⱼ (hereinafter may be called by a generic name “consideration 41”) for its use to the IP market 22 (or the IP market 22 collects the consideration 41) in response to a frequency of use. The frequency of use can be determined on the basis of the number of semiconductor devices manufactured by the user 12 using the IP 31.

The full amount of the consideration 41ᵢⱼ paid from the user 12ⱼ or earnings 42ᵢⱼₖ (hereinafter may be called by a generic name “earnings 42”) figured out by deducting expenses such as those for future upkeeping of the IP market 22 from the consideration 41ᵢⱼ are paid to the vendor 11ₖ (1≦k≦P) providing the IP 31ᵢ to the IP market 22. Trade of the consideration 41 and the earnings 42 is performed in a medium such as electronic commerce. The consideration 41 can be traded in electronic commerce through a network used for obtaining the IP 31 from the IP market 22 by such means as download. Further, the earnings 42 can be traded in electronic commerce through a network used for providing the IP 31 to the IP market 22. The download of the IP 31 to the user 12 is allowed by paying the consideration 41 previously. The storage of the downloaded IP31 may be allowed in information storage media on the side of the user 12 of the IP 31 such as IC (integrated circuit) card, DVD (digital video disc), HDD (hard disc drive), MD (mini disc), MT (magnetic tape), DAT (digital audio tape), MO (magneto optical disc), FD (flexible disc), CD-ROM (compact disc read only memory) and CD-RW (compact disc rewritable).

Following the above-described trade of the IP 31, a reward worthy of the IP 31 can be passed on to the vendor 11 providing the same. The vendor 11 is thereby encouraged to make IP 31 of high quality open to the public.

Stocks 32₁, 32₂, . . . 32_{N} (hereinafter may be called by a generic name “stocks 32”) issued respectively for the IPs 31₁, 31₂, . . . 31_{N} are provided to investors 13₁, 13₂, . . . 13_{Q} (hereinafter may be called by a generic name “investor 13”). More particularly, the investor 13 buys the stocks 32 from the IP market 22 and pays its consideration 44. A plurality of stocks issued for one IP can be shared among a plurality of investors. The full amount of consideration 44ᵢₜ paid from an investor 13ₜ (1≦t≦Q) for stocks 32ᵢ issued for the IP 31ᵢ or earnings 45ᵢₖ figured out by deducting expenses such as those for future upkeeping of the IP market 22 from the consideration 44ᵢₜ are paid to the vendor 11ₖ providing the IP 31_{i.}

The investor 13 having the stocks 32 is entitled to receive allotment 43 from the vendor 11 providing the IP 31 on the basis of the consideration 41 for use of the IP 31 for which the stocks 32 are issued. For example, allotment 43ᵢₖₜ is paid from the vendor 11ₖ providing the IP 31ᵢ to the investor 13ₜ buying the stocks 32ᵢ of the IP 31_{i.}

When the allotment 43 of the stocks 32 is high, the value of the stocks 32 is possibly increased. Accordingly, capital gains of the investor 13 can be produced potentially. Electronic commerce can be available as well for allocation of the allotment 43 and buying of the stocks 32. Buying and selling of the stocks 32 are established in the IP market 22, and they can be intermediated by securities companies assigned to the IP market 22. The allotment 43ᵢₜₖ can be an increased amount of the stocks 32ᵢ obtained by split-up besides money. Further, the complimentary use of the IP 31ᵢ such as use at a lower cost than the normal user 12 can be applicable further as the allotment 43_{ikt.}

As described above, an incentive of the investor 13 to buy the stocks 32 can be excited by allocating the allotment 43 to the investor 13 having the stocks 32. Accordingly, the vendor 11 of the IP 31 can raise funds easily from the investor 13. A probability of buying of the stocks 32 by the investor 13 issued for the IP 31 promising frequent use is high so that the vendor 11 providing the IP 31 can recover development funds before use of the IP 31. For this reason, the vendor 11 is encouraged to make the IP 31 of high quality open to the public.

The IP market 22 thereby contributes to developments in the semiconductor industry. Further, since the IP 31 is distributed electromagnetically, it can be obtained and used easily by the user 12. In addition, payment of the consideration for use of the IP 31 can be realized rapidly and easily through delivery and receipt of electromagnetic signals in electronic commerce, to thereby excite active use of the IP 31.

The IP 31 has values in two aspects defined by relations among the trade of use of the IP 31, stocks 32 and allotment 43 as described above. One is the consideration 41 for use of the IP 31 and the other is the price of the stocks 32 issued for the IP 31. The price of the stocks 32 is a market price determined by buying and selling by the investor 13 in the IP market 22. In order to establish a fair market price, the allotment 43ᵢₜₖ is increased or decreased in response to the earnings 42_{jk.} Therefore, it is desirable to increase or decrease the allotment 43ᵢₖₜ in response to a frequency of use of the IP 31ᵢ by the user. For example, a frequency of use 51 is transmitted from the market 22 to the vendor 11, on the basis of which the allotment 43 is paid from the vendor 11 to the investor 13.

The consideration 41 for use of the IP 31 can be a value (hereinafter referred to as “consideration coefficient”) obtained by multiplying the price of the stocks 32 and a predetermined certain coefficient. The consideration coefficient may be revised regularly based on the condition of use of the IP 31. The consideration 41 can be thereby indexed to the market price of the stocks 32 issued for the corresponding IP 31.

It is desirable that IP for which stocks are to be issued be of high quality, namely satisfy certain standards so that burden of use of the IP 31 by the user such as design and proving be reduced. In order to secure these standards, the IP 31 to be provided in the market 22 should satisfy certain standards established by a screening committee 21. Namely, the stocks 32 are issued only for the IPs 31ᵢ, 31₂, . . . 31_{N} satisfying certain standards among a group of IPs 30. The consideration coefficient may be established by the screening committee 21.

On receipt of a request from the vendor 11 to list the group of the IPs 30, the screening committee 21 performs screening covering various items. In preparation for such screening, it is also one of the preferable aspects of the present invention to obligate the vendor 11 to submit a preproduction test chip manufactured by using the group of IPs 30 to be provided from the vendor 11 and information as proved to the screening committee 21.

The items of the screening for the group of IPs 30 may be those as cited below:

1. Performance evaluations (such as operating speed, power consumption and occupied area)

2. Compatibility with other IPs (operating conditions for obtaining compatibility, flexibility and degree of difficulty in clock division)

3. Dependency on manufacturing steps (flexibility of processes, OPC (optical proximity correction) during transcription step to peripheral IPs)

4. Is IP described in certain description languages (such as C, C++, VHDL, Verilog-HDL and System C)?

5. Prediction of variations resulted from layout patterns of IP

6. Does IP have distinctions over existing IPs already listed on the market? (originality of IP)

7. Is there any possibility of illegal use of patent issued for IP?

8. Are proving methods and programs of the group IP disclosed correctly?

The group of IPs 30 satisfying the foregoing items for the screening are approved to be listed on the market 22 as the IP 31 satisfying certain standards and disclosed in the market 22. The relation between types of design data included in the IP 31 to be disclosed and development levels is shown in Table 2.

TABLE 2

| | | Design Stage | | | | | |
|---|---|---|---|---|---|---|---|
| | | | | Logic Level | | | |
| | | Specification | High | RTL + | | Physical Level | |
| Data Type | | Level | Level | Script | Net List | Layout | Mask |
| Design | Directions | ◯ | ◯ | ◯ | ◯ | ◯ | ◯ |
| Data | IP Architecture Description | ◯ | ◯ | ◯ | ◯ | ◯ | ◯ |
| | Languages (such as C and C ++) | | | | | | |
| | Functional Operating | | ◯ | ◯ | ◯ | ◯ | ◯ |
| | Information | | | | | | |
| | RTL (Register Transfer Level) | | | ◯ | ◯ | ◯ | ◯ |
| | Language | | | | | | |
| | Synthesis Script | | | ◯ | ◯ | ◯ | ◯ |
| | Net List | | | | ◯ | ◯ | ◯ |
| | Simulation Data | ◯ | ◯ | ◯ | ◯ | ◯ | ◯ |
| | Test Data | | | ◯ | ◯ | ◯ | ◯ |
| | Floor Plan Data | | | | | ◯ | ◯ |
| | Layout Data | | | | | ◯ | ◯ |
| | Timing Data | ◯ | ◯ | ◯ | ◯ | ◯ | ◯ |
| | Capacitance/Resistance Data | | | | | ◯ | ◯ |
| | Mask Data | | | | | ◯ | ◯ |

Development of semiconductor devices such as system LSIs includes stages such as a consideration stage of system LSI development, a specification level design stage, a high level design stage, a logic level design stage and a physical level design stage. In the consideration stage of system LSI development, factors such as function, quality, provider, cost of IP (which are not shown in Table 2 above) are required. In the specification level design stage, factors such as directions for architecture evaluation and detailed specifications in IP architecture description languages are required.

In the high level design stage, factors such as directions for operating level simulation and operating level synthesis, functional operating information and simulation data are required.

In the logical level design stage, factors such as net list and test data are required for the purposes of logical provings (RTL simulation, logical synthesis, test synthesis, chip design planning, gate level simulation and timing analysis, for example). In the logical level design stage, furthermore, factors such as directions, net list, simulation data, test data, floor planning data, layout data, timing data, capacitance/resistance data and mask data are required for the purposes of implementation/chip variations (layout, automatic timing control, test pattern automatic generation, for example).

In the physical level design stage, factors such as layout correction information resulted from semiconductor manufacturing steps (OPC, phase shifter and chemical mechanical polishing dummy patterns, for example) are required in addition to layout information. It is one of the preferable aspects of the present invention that the above-described data be made open to the public in the market 22.

The user 12 may hope to use only a part of the above information of the IP 31 listed on the market. For example, the user 12 may perform the physical level design stage by himself or herself using only the data necessary for each of the design stages at specification level, high level and logical level. In this case, it is possible to pay the consideration 41 for use on the basis of condition, for example, an amount of information to be used among the above information of the IP 31 listed on the market. Active use of the IP 31 can be excited accordingly.

It is desirable that the IP 31 to be downloaded to the user 12 have identification such as identification number assigned thereto that is specific to the type of the IP and the user 12. It is therefore easy to associate the user 12 with the IP 31 distributed to the user 12. Due to this, even when duplication of the IP 31 is easy and use of the same may be possible by the person other than the user 12 to which the IP 31 is distributed, such use of the IP 31 can be detected easily. It is more desirable to obligate the user 12 to record the identification number of the IP 31 and identification numbers of semiconductor devices themselves on all the semiconductor devices (chips) manufactured by using the IP 31 downloaded by the user 12 and to report these identification numbers to the market 22. The identification numbers may be issued from the market 22.

When the user 12 encounters a problem 61 about the IP 31, it is brought over to a supporting committee 23. The supporting committee 23 reviews the problem 61 and provides the user 12 with a particular solution 62. The supporting committee 23 reviews the problem 61 for each IP 31 and reports the quality of the IP 31 to the screening committee 21 regularly. The supporting committee 23 consists of organizations such as commercial enterprises (members of the market 22) for carrying out these activities. The screening committee 21 determines rating of the IP 31 listed on the market, which is made open to the public regularly. In addition, when the quality of the IP 31 as listed on the market is considerably low and cannot satisfy demand, the screening committee 21 is entitled to determine delist of the IP 31. It is one of the preferable aspects of the present invention that the screening committee 21 and the supporting committee 23 behave in this way.

Besides the stocks 32, various types of securities may be issued. For example, bonds allowing stock option and convertible IP bonds that can be converted into the stocks 32 may be issued. Stock option allowing right to obtain the stocks 32 at a certain price may be granted from a proprietor who is the vendor 11 to an employee who is a developer of the IP 31, for example. Convertible IP bonds can be converted into the stocks 32 when the market price of the IP 32 reaches or exceeds a certain price. When the market price of the IP 32 remains below the certain price, a predetermined amount of money is reimbursed to an owner of the convertible IP bonds.

The IP related to semiconductor devices is taken as an example in the foregoing preferred embodiment. The present invention is applicable further to copyright such as sentences, music, movies, images and intellectual property such as software and patents.

While the invention has been shown and described in detail, the foregoing description is in all aspects illustrative and not restrictive. It is therefore understood that numerous modifications and variations can be devised without departing from the scope of the invention.

What is claimed is:

1. A method of providing information, comprising the steps of:
(a) providing security of information to an investor distributed electromagnetically to a user and paying at least part of consideration for said security to a vendor providing said information;
(b) paying at least part of consideration for use of said information by said user to said vendor; and
(c) paying allotment from said vendor to said investor.

2. The method of providing information according to claim 1, wherein said step (a) includes the step of:
(a1) making said security only of said information satisfying a predetermined standard open to the public.

3. The method of providing information according to claim 1, wherein identification is assigned to said information, said identification being specific to said user.

4. The method of providing information according to claim 1, wherein said step (b) is performed in electronic commerce.

5. The method of providing information according to claim 1, wherein said consideration for said use is determined on the basis of condition of use of said information in said step (b).

6. The method of providing information according to claim 1, wherein said allotment to said investor buying said security corresponding thereto is determined on the basis of frequency of use of said information in said step (c).

7. A method of providing information in which information is distributed electromagnetically from a vendor to a user through a market, said market performing the steps of:
(a) making security of said information open to the public to establish buying and selling by an investor;
(b) distributing said information electromagnetically to said user to collect consideration for said use from said user; and
(c) transmitting frequency of said use to said vendor to provide at least part of said consideration for said use to said vendor.

8. The method of providing information according to claim 7, wherein said step (a) includes the step of:
(a1) making said security only of said information satisfying a predetermined standard open to the public.

9. The method of providing information according to claim 7, wherein identification is assigned to said information, said identification being specific to said user.

10. The method of providing information according to claim 7, wherein said step (b) is performed in electronic commerce.

11. The method of providing information according to claim 7, wherein said consideration for said use is determined on the basis of said condition of use of said information in said step (b).

12. The method of providing information according to claim 7, further comprising the step of:
(d) determining allotment to said investor buying said security corresponding thereto on the basis of said frequency of use of said information.

13. A method of providing information in which a vendor performs the steps of:
(a) distributing information electromagnetically to a user;
(b) receiving at least part of consideration for use of said information by said user; and
(c) paying allotment to an investor buying security of said information on the basis of frequency of use of said information.

14. The method of providing information according to claim 13, wherein said step (a) includes the step of
(a1) making said security only of said information satisfying a predetermined standard open to the public.

15. The method of providing information according to claim 13, wherein identification is assigned to said information, said identification being specific to said user.

16. The method of providing information according to claim 13, wherein said step (b) is performed in electronic commerce.

17. The method of providing information according to claim 13, wherein said consideration for said use is determined on the basis of condition of use of said information in said step (b).

18. The method of providing information according to claim 13, wherein said allotment to said investor buying said security corresponding thereto is determined on the basis of said frequency of use of said information in said step (c).
